(19) United States
(12) Patent Application Publication
(10) Pub. No.: US 2002/0059102 A1
(43) Pub. Date: May 16, 2002

(54) Method and system for advertising on the internet

(75) Inventors: Eun-Sook Sung, Gunpo-si (KR); Sang-Rok Han, Suwon-si (KR)

Correspondence Address: SUGHRUE, MION, ZINN, MACPEAK & SEAS, PLLC, 2100 Pennsylvania Avenue, NW, Washington, DC, 20037-3213, US

(73) Assignee: SAMSUNG ELECTRONICS CO., LTD.

(21) Appl. No.: 09/970,680

(22) Filed: Oct. 5, 2001

(30) Foreign Application Priority Data
Nov. 16, 2000 (KR) 2000-68195

(51) Int. Cl. G06F 17/60; G06F 17/30; G06F 7/00

(52) U.S. Cl. 705/14

(57) ABSTRACT

A method and a system for advertising on the Internet, which provide a plurality of advertisements in limited areas on a web page. The method includes the steps of: (a) grouping advertisements which can be displayed in at least one predetermined area of a web page; (b) determining a sequence for the advertisements included in the groups according to predetermined criteria; (c) assigning channel numbers to the advertisements on the basis of the determined sequence; and (d) establishing a database to connect the predetermined areas to the groups of advertisements and the channel numbers. Therefore, a web page provider can increase advertising revenues, various advertisements can be provided to a user, and the user can be made to stay connected to the corresponding site for a longer period of time.

### BACKGROUND OF THE INVENTION

1. Field of the Invention

The present invention relates to a method and a system for advertising on the Internet. More particularly, to a method and a system for advertising using an arbitrary limited area set to provide advertisements on a web page on the Internet. The present application is based on Korean Patent Application No. 2000-68195 which is incorporated herein by reference.

2. Description of the Related Art

Generally, a good example of an advertisement using an arbitrary limited area set to provide advertisements on a web page on the Internet is a banner advertisement. One banner advertisement is displayed in one banner advertisement area. If a user clicks on the banner advertisement area, the user's Internet browser is linked to a uniform resource locator (URL) of a corresponding advertiser.

The number of banner advertisements which can be provided on a single web page is limited. This is because it is impossible to provide advertisements without providing any other content, and because the area of the web page is limited. Therefore, banner advertisements have a limited effect and generate only a limited income for a web page provider. Also, a user may understand the contents of a banner advertisement at a glance. If it is not necessary to link to the website corresponding to the banner advertisement, the banner advertisement area may never be clicked on.

### SUMMARY OF THE INVENTION

To solve the above problems, it is an objective of the present invention to provide a method and a system for advertising on the Internet, that provide a plurality of advertisements in an arbitrary limited area set to provide advertisements on a web page.

It is another objective of the present invention to provide a method and a system for advertising on the Internet, that provide a plurality of advertisements by grouping and assigning channel numbers to the advertisements which can be provided in arbitrary limited areas set to provide advertisements on a web page.

It is another objective of the present invention to provide a method and a system for advertising on the Internet, that provide a plurality of advertisements, which can be provided in arbitrary limited areas set to provide advertisements on a web page, by classifying the advertisements according to advertisers or categories.

Accordingly, to achieve the above objectives, there is provided a method including (a) grouping advertisements which can be displayed in at least one predetermined area on a web page; (b) determining a sequence of the advertisements included in the groups according to predetermined criteria; (c) assigning channel numbers to the advertisements on the basis of the determined sequence; and (d) establishing a database to connect the predetermined areas to the groups of advertisements and the channel numbers.

It is preferable that in (a), the advertisements are grouped according to advertisers or service categories.

Also, it is preferable that the method further includes (e) displaying an advertisement in the predetermined area on a web page; (f) shifting to a channel number of the next advertisement in the sequence if the next advertisement in the sequence is requested by a user; (g) searching for an advertisement corresponding to the shifted channel number; and, (h) displaying the advertisement searched in the predetermined area.

Also, to achieve the above objectives, there is provided a system for advertising on the Internet, in which at least one user terminal and a server are connected through the Internet. The system preferably includes: a database for storing information about advertisements grouped with respect to at least one predetermined area, in which the advertisements can be displayed on a web page provided to at least one user terminal through the Internet; and a server for storing information about the advertisements in the database and providing advertisements to a user terminal, whereby a next advertisement in the sequence is displayed in the predetermined area with reference to the database if the next advertisement in the sequence is required to be displayed in the predetermined area by the user terminal.

### BRIEF DESCRIPTION OF THE DRAWINGS

The above objectives and advantages of the present invention will become more apparent by describing in detail preferred embodiments thereof with reference to the attached drawings in which:

FIG. 1 is a functional block diagram illustrating a system for advertising on the Internet according to the present invention;

FIG. 2 is a flow chart of a process of assigning channel numbers to advertisements according to limited areas set to provide advertisements on a web page in a method for advertising on the Internet according to the present invention;

FIG. 3 is a flow chart of a process of providing advertisements in limited areas set to provide advertisements on a web page in a method for advertising on the Internet according to the present invention; and

FIG. 4 is an example of an arbitrary limited area set to provide advertisements on a web page for explaining a request to display a next advertisement in the sequence by a user.

### DETAILED DESCRIPTION OF THE INVENTION

Hereinafter, preferred embodiments of the present invention will be described in greater detail with reference to the appended drawings.

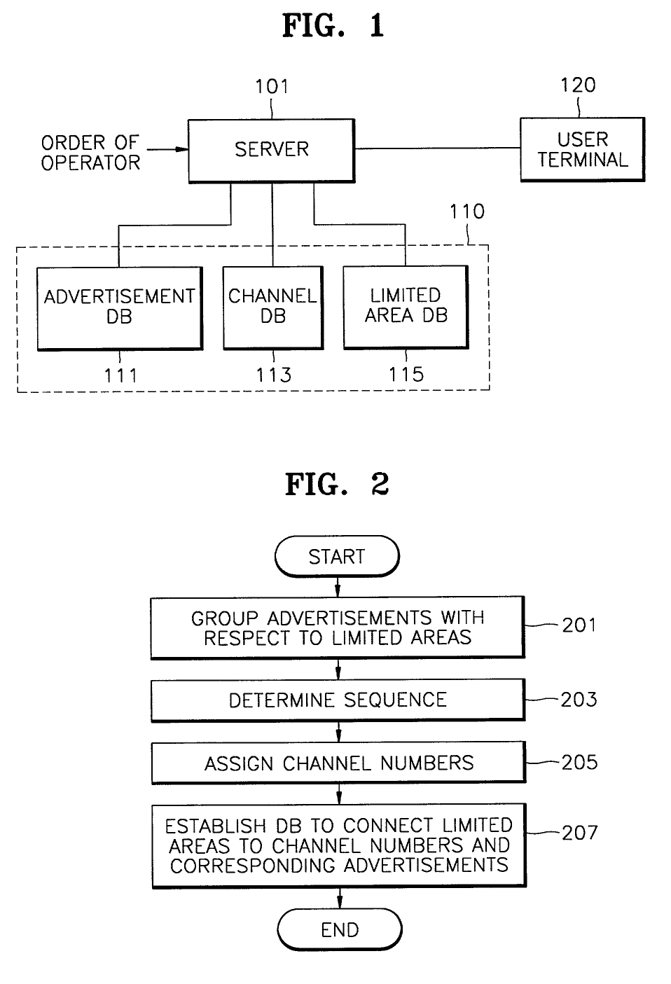

FIG. 1 is a functional block diagram illustrating a system for advertising on the Internet according to the present invention. Referring to FIG. 1, the system includes a server 101 which operates a website, a database (DB) 110 where information related to advertisements is stored, and a user terminal 120.

The DB 110 includes an advertisement DB 111 where substantial advertisement information is stored, a channel DB 113 where channel information assigned to respective advertisements is stored, and a limited area DB 115 where information about limited areas set to provide advertisements on web pages is stored.

FIG. 2 is a flow chart illustrating a process of assigning channel numbers to advertisements according to the limited areas set to provide advertisement on a web page in a method of advertising on the Internet according to the present invention. Referring to FIG. 2, the process of assigning channel numbers to advertisements according to the limited areas includes step 201 of grouping advertisements according to the limited areas, step 203 of determining a sequence of the grouped advertisements, step 205 of assigning channel numbers on the basis of the determined sequence, and step 207 of establishing a database to connect the limited areas to the channel numbers and the corresponding advertisements.

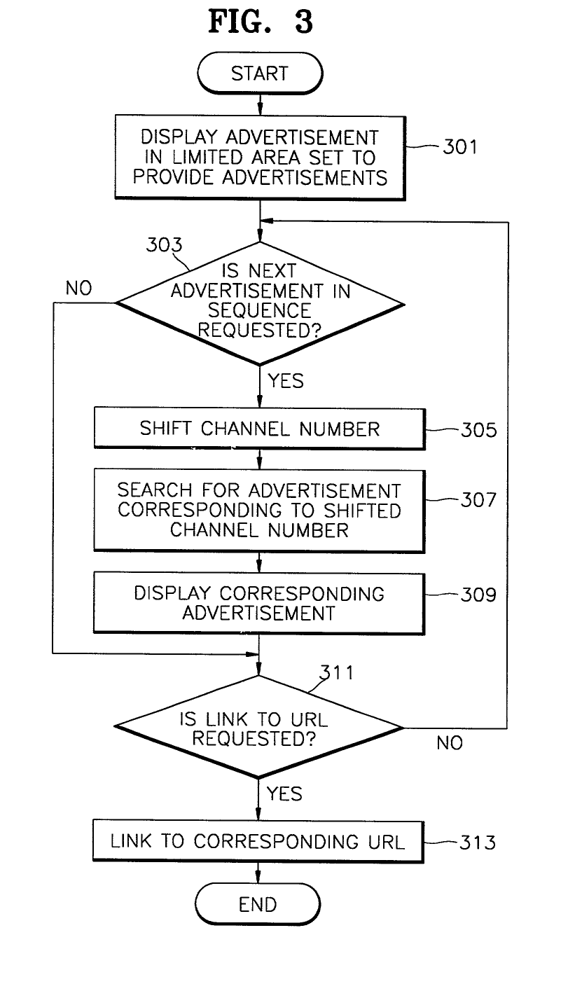

FIG. 3 is a flow chart illustrating a process for providing advertisements in the limited areas on a web page by the method of advertising on the Internet according to the present invention. Referring to FIG. 3, the process for providing advertisements includes step 301 of displaying an advertisement having a predetermined position in a sequence in a predetermined limited area on a web page, step 303 of checking whether a next advertisement in the sequence is requested by a user when an advertisement having a predetermined position in a sequence is displayed in a limited area, step 305 of shifting to a next channel number in the sequence if a next advertisement in the sequence is required, step 307 of searching for an advertisement corresponding to the shifted channel number, step 309 of displaying the corresponding advertisement, step 311 of checking whether a link to a website using URL is required, and step 313 of linking to the corresponding website.

Referring to FIGS. 1 through 3, preferred embodiments of the present invention will be described in greater detail.

First, the server 101 groups advertisements by limited areas set to provide advertisements on a web page in step 201 shown in FIG. 2. That is, if for example, there are 5 limited areas set to provide advertisements on a web page, advertisements are grouped with respect to the 5 limited areas, thus forming 5 advertisement groups. The limited areas may be, for example, banner advertisement areas, bit map areas, or gif areas on a web page. Of course, those skilled in the art would be aware of other data compression techniques as well that could be used to process data for certain areas on a web page.

Also, in step 201, when advertisements are grouped, the advertisements can be randomly selected and grouped, or they can be selected and grouped according to advertisers or service categories. If selecting and grouping by advertisers, the affiliated companies which separately operate the websites of “Samsung Group”, for example, can be formed as one group. If selecting and grouping by service categories, “air transportation companies”, for example, can be formed as one group. That is, Korean Air, Delta Airlines, American Airlines, Asiana Airlines can be formed as one advertisement group.

In this way, after the advertisements are grouped with respect to the respective limited areas in step 203, the server 101 determines a sequence of the grouped advertisements. This is performed by the group. For example, if 5 groups having 4 advertisements each are formed, a separate sequence of the 4 advertisements in a group is determined for each of the 5 groups. The sequence may be determined in consideration of factors such as the income generated for a website by the advertisement, such that the profits of the website can be increased. The number of advertisements belonging to the respective groups may be different.

In step 205, the server 101 assigns channel numbers to the respective advertisements. That is, on the basis of the sequence determined in the step 203, the channel numbers are assigned to the advertisements included in the respective groups.

For example, if 4 advertisements belong to one group as described above, a channel number ‘1’ is assigned to an advertisement determined to be first among the 4 advertisements in the sequence, a channel number ‘2’ is assigned to the next advertisement in the sequence, a channel number ‘3’ is assigned to an advertisement determined to be third among the 4 advertisements in the sequence, and a channel number ‘4’ is assigned to an advertisement determined to be last among the 4 advertisements in the sequence.

Next, the server 101 establishes a DB 110 in step 207. That is, the information about the limited areas set to provide advertisements available on a web page is stored in the limited area DB 115. Channel information of the respective advertisements is stored in the channel DB 113. Advertisement information is stored in the advertisement DB 111. Here, the server 101 connects the limited area information to the channel information of the advertisements and the advertisement information, and stores them so as to sequentially display the advertisement information in the limited areas.

That is, due to the server 101, the DB 110 recognizes the channel number of the advertisements belonging to the respective limited areas with reference to the limited area DB 115, recognizes information about the advertisements which have been assigned respective channel numbers with reference to the channel DB 113, and finds substantial advertisements on the basis of the information about the advertisements recognized by the server 101 with reference to the advertisement DB 111. The limited area DB 115, the advertisement DB 111, and the channel DB 113 may be established as one DB.

In this way, if organization of the information on the advertisements which can be displayed in the respective limited areas is completed, the server 101 provides the advertisements in the way illustrated in FIG. 3. FIG. 3 illustrates a process performed under the assumption that the user terminal 120 is already linked to the server 101 through the Internet, and a website of the server 101 is displayed on the user terminal 120.

In step 301, the advertisements are displayed on the limited areas set to provide advertisements on the website on the user terminal 120. In step 303, it is determined whether a next advertisement in the sequence allocated in an arbitrary limited area is requested by the user terminal 120. If it is determined, in step 303, that a next advertisement in the sequence of an arbitrary limited area is requested by the user terminal 120, the server shifts to a next channel number in the sequence in step 305. For example, the server 101 updates the channel number by adding or subtracting 1 to the channel number of the advertisement currently displayed.

In step 307, the server 101 searches for the advertisement corresponding to the shifted channel number (updated channel number). That is, referring to the channel DB 113 using the shifted channel number, information about the corresponding advertisement is obtained. On the basis of the obtained information, the corresponding advertisement is obtained from the advertisement DB 111.

In step 309, to display the corresponding advertisement on the corresponding limited area, the server 101 transmits the corresponding advertisement to the user terminal 120.

In step 311, it is determined whether the server 101 is required to link to the URL of the advertisement currently displayed. If linking is required, the server 101 links to the corresponding URL in step 313. Linking to the corresponding URL means linking to a website having the corresponding URL.

However, in step 303, if a next advertisement in the sequence is not required, the server 101 performs step 311. If a link to the corresponding URL is not required in the step 311, the server performs step 303 again. The way in which the server 101 checks whether a next advertisement in the sequence is required can be based on the number of times the corresponding limited area is clicked on. For example, if a limited area is clicked on one time, a next advertisement in the sequence is determined to be required, and if a limited area is clicked on two times, it can be determined that a link to the URL of the corresponding website is required.

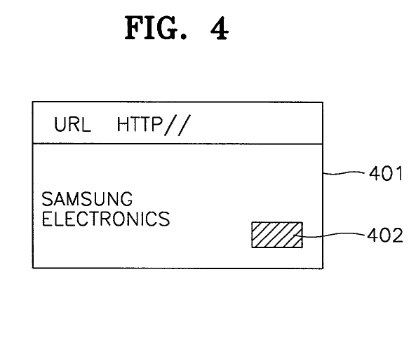

Alternatively, as shown in FIG. 4, the server 101 detects whether a next advertisement in the sequence is requested by checking whether an area 402, within the corresponding limited area 401 set to provide advertisements, is clicked on. 402 of FIG. 4 is an area which is clicked on when a user intends to transmit a message requesting a next advertisement in the sequence.

According to the present invention, a plurality of advertisements are configured to be displayed in limited areas set to provide advertisements on a web page, so that a web page provider can increase advertising revenues, and various advertisements can be provided to a user, and the user can be made to stay connected to the corresponding site for a longer period of time.

Also, advertisements can be grouped or categorized, so that a user can easily find an advertisement that he wants, and it is easy to compare and analyze the advertisements.

What is claimed is:

1. A method of advertising on the Internet comprising:
(a) grouping advertisements which can be displayed in at least one predetermined area of a web page;
(b) determining a sequence for the advertisements included in the groups according to predetermined criteria;
(c) assigning channel numbers to the advertisements on the basis of the determined sequence; and
(d) establishing a database to connect the predetermined areas to the groups of advertisements and the channel numbers.

2. The method of claim 1, wherein in process (a), if the number of the predetermined areas is n, the advertisements are grouped into n service groups corresponding to the respective n predetermined areas.

3. The method of claim 1, wherein in process (a), the advertisements are grouped according to advertisers or service categories.

4. The method of claim 1, further comprising:
(e) displaying an advertisement in the predetermined area on a web page;
(f) shifting to a channel number of a next advertisement in the sequence if the next advertisement in the sequence is requested by a user;
(g) searching for an advertisement corresponding to the shifted channel number; and
(h) displaying the advertisement searched in the predetermined area.

5. The method of claim 4, further comprising (fl) determining whether the user requires the next advertisement in the sequence to be displayed in the predetermined area by the number of times the predetermined area is clicked on or determining whether the user transmits a message requesting the next advertisement in the sequence.

6. The method of claim 4, wherein in process (f), it is determined that the advertisement corresponding to the next advertisement in the sequence is requested by the user if the user clicks one time on an icon in the predetermined area or one time on the advertisement displayed in the predetermined area.

7. The method of claim 5, further comprising (i) linking to a website if a link to the website of the advertisement displayed in the predetermined area is requested by the user.

8. The method of claim 7, wherein it is determined that the link to the website of the advertisement is requested by the user if the user clicks two times on an icon in the predetermined area or two times on the advertisement displayed in the predetermined area.

9. The method of claim 1, wherein the predetermined areas are banner advertisement areas, bit map areas, or gif areas.

10. A system for advertising on the Internet comprising:
a database for storing information about advertisements grouped with respect to at least one predetermined area in which the advertisements can be displayed on a web page provided to at least one user terminal through the Internet; and
a server for storing information about the advertisements in the database, and providing advertisements to a user terminal, whereby a next advertisement in a sequence of advertisements is displayed in the predetermined area with reference to the database if the next advertisement in the sequence is required to be displayed in the predetermined area by the user terminal.

11. The system of claim 10, wherein if a link to a website of the advertisement displayed in the predetermined area is requested by the user terminal, the corresponding website and the user terminal are linked.

12. The system of claim 10, wherein the database recognizes a channel number of the advertisements belonging to a respective predetermined area, recognizes the information about the advertisements which have been assigned respective channel numbers and determines a number of advertisements based on said information.

13. A method of advertising on the Internet, the method including:
(a) displaying grouped advertisements in at least one predetermined area of a web page;
(b) determining a sequence for the advertisements, included in the groups, according to predetermined criteria;
(c) assigning channel numbers to the advertisements on the basis of the determined sequence; and
(d) connecting the predetermined areas to the groups of advertisements and the channel numbers by establishing a database.

14. The method of claim 13, wherein in (a), if the number of the predetermined areas is n, the advertisements are grouped into n service groups corresponding to the respective n predetermined areas.

15. The method of claim 13, wherein (a) comprises grouping the advertisements according to advertisers or service categories.

16. The method of claim 13, further comprising:
(e) displaying an advertisement in the predetermined area on a web page;
(f) if the next advertisement in the sequence is requested by a user, shifting to a channel number of a next advertisement in the sequence;
(g) searching for an advertisement corresponding to the shifted channel number; and
(h) displaying the advertisement searched in the predetermined area.
